(19) United States
(12) Patent Application Publication
(10) Pub. No.: US 2020/0288723 A1
(43) Pub. Date: Sep. 17, 2020

(54) METHOD OF IMPROVING STORAGE STABILITY AND FITNESS OF FUNGAL SPORES

(71) Applicant: Bayer CropScience Biologics GmbH, Wismar (DE)

(72) Inventors: Daniel LANVER, Wismar (DE); Fred NEUMANN, Wismar (DE); Tim STEINORT, Wismar (DE); Stefan SCHINK, Wismar (DE)

(21) Appl. No.: 16/648,979

(22) PCT Filed: Sep. 17, 2018
(86) PCT No.: PCT/EP2018/075012

§ 371 Date: Mar. 19, 2020

(30) Foreign Application Priority Data
Sep. 20, 2017 (EP) 17192142.2

(51) Int. Cl. A01N 63/30

(52) U.S. Cl. CPC A01N 63/30

(57) ABSTRACT

The present invention relates to a method for producing dormant fungal structures or organs with an improved germination rate comprising subjecting said dormant structures or organs to a procedure comprising a heat treatment, followed by a cooling period as well as a related solid-state fermentation method and dormant fungal structures or organs produced thereby.

Biological control agents become more and more important in the area of plant protection, be it for combatting various fungal or insect pests or for improving plant health. Although also viruses are available which can be used as biological control agents, mainly those based on bacteria and fungi are used in this area. The most prominent form of biological control agents based on fungi are the asexual spores called conidia as well as blastospores, but also other fungal propagules may be promising agents, such as (micro)sclerotia, ascospores, basidiospores, chlamydospores or hyphal fragments.

WO2017/117089 discloses ways to stabilize bacterial endospores, more particularly spores of the genus Bacillus, using some kind of heat treatment.

Unlike many bacterial spores, such as Bacillus spores, many fungal spores are less robust and it has proven to be difficult to provide fungal spores in a form which meets the needs of commercial products, in particular acceptable storage stability at certain temperatures. Whereas this problem in the past has been addressed mainly by developing improved formulations individually per fungal species, there is still the need to provide for a general method of improving storage stability of fungal spores which does not need extensive experimentation in order to find a suitable formulation per species. Furthermore, for the case of particularly delicate fungal spores, such as those belonging to the genus Metarhizium, it is still desirable to provide more stable spores with enhanced shelf-life.

This technical problem has at least partially been solved in the present invention.

Accordingly, in one aspect the present invention relates to a method for producing dormant fungal structures or organs with an improved germination rate comprising subjecting said dormant structures or organs to a procedure comprising a heat treatment of between 37° C. and 65° C., followed by a cooling period at a temperature of between 0° C. and 36° C.

Dormant fungal structures or organs in connection with the present invention include fungal spores such as conidia, ascospores, basidiospores, chlamydospores and blastospores as well as other dormant structures or organs such as sclerotia and microsclerotia in all stages of their development, i.e. during and after maturation. Preferably, the spores are exospores, more preferably conidia. It is also preferred that the spores are at least partially mature spores. Most preferably, the spores are mature spores. If spores are present in all stages of development, it is preferred that at least 50% of them are mature spores. An overview of conidial development can be found e.g. in Navarro-Bordonaba and Adams (1994; Development of Conidia and Fruiting Bodies in Ascomycetes; Esser and Lemke (Edt.)—The Mycota;—I. Growth, Differentiation and Sexuality; Springer-Verlag ISBN 978-3-662-11910-5).

Several differences exist between bacterial and fungal spores (Setlow, 2007, Trends in Microbiology 15(4): 172-180; Wyatt et al., 2013, Advanced Applied Microbiology 85:43-91) starting with the composition of the spore wall, which consists mainly of beta-glucan in fungal spores and of peptidoglycan in bacterial spores. Furthermore, bacterial spores are exclusively produced to survive harsh environmental conditions, whereas fungal spores are a means of reproduction. At least spores of the bacterial genus Bacillus are endospores, i.e. they are formed within the bacterium. In contrast, fungal spores, at least those of fungal species which are useful in plant protection, are predominantly exospores, which means that they originate from the outside the fungal body. Furthermore, whereas bacterial spores, in particular endospores, have been shown to display a high temperature tolerance, fungal spores are more sensitive towards higher temperatures.

In connection with the present invention, an “improved germination rate” refers to a germination rate of dormant fungal structures or organs, preferably fungal spores, which is at least 10% higher than that of dormant fungal structures or organs, such as spores not treated according to the procedure of the present invention but treated equally otherwise (“control spores”), preferably at least 20%, more preferably at least 30% or at least 40% and most preferably at least 50% higher until at least 2 weeks after production of said spores, that is after finishing the cooling period. In other words, “improved germination rate” means a germination rate of at least 110% of that of control spores, preferably at least 120%, more preferably at least 130% or at least 140% and most preferably at least 150% or higher until at least 2 weeks after production of said spores. Preferably, said improved germination rate is still visible or even increased until at least 3 months after production, more preferably at least 4 months and most preferably at least 6 months after production, such as at least 8 months, at least 10 months or even 12 months or more. Accordingly, it is preferred that the germination rate of spores treated according to the invention is at least 200% of that of control spores 3 months after production of said spores. In another preferred embodiment, the germination rate is at least 300% or at least 400%, most preferably at least 500% of that of control spores 6 months after production of said spores. The germination rate in this connection denotes the ability of spores to still germinate after a given time. % germination rate accordingly means the percentage of spores which is able to germinate after a given time. Methods of measuring the germination rate are well-known in the art. For example, spores are spread onto the surface of an agar medium, and the proportion of spores developing germ tubes is determined microscopically after incubation at appropriate growth temperatures (Oliveira et al., 2015. A protocol for determination of conidial viability of the fungal entomopathogens Beauveria bassiana and Metarhizium anisopliae from commercial products. Journal of Microbiological Methods 119; pp: 44-52, and references therein).

The dormant fungal structures or organs, such as fungal spores, or compositions comprising dormant fungal structures or organs, such as fungal spores produced according to the present method display an increased storage stability as compared to control spores or compositions comprising control spores. “Storage stability” or “storage stable” in connection with the present invention means the ability of fungal spores to be stored over a prolonged time which is longer than 24 h, preferably longer than 48 hours, such as at least 1 week, at least 4 weeks, more preferably at least 1 month, such as at least 2 months or at least 6 months, preferably at room temperature, more preferably also without a significant decrease in the germination rate of the spores. Storage stability in a commercial product according to the above definition may include a certain guaranteed germination rate which is, however, dependent upon the initial spore concentration and fungal species.

An increased storage stability refers to said dormant fungal structures or organs, such as spores being able to be stored for a significantly longer time as compared to spores produced by the same fermentation method without the treatment according to the present invention under the same conditions such as in the same formulation and at the same temperature.

Furthermore, the dormant fungal structures or organs according to the present method display an improved re-activation of metabolic activity as revealed by resazurin-based redox indicators (see Material & Methods and Example 7).

Another positive effect of the treatment according to the invention is that the dormant fungal structures or organs, in particular spores gain a higher temperature tolerance. The temperature tolerance is here defined as the ability of said dormant fungal structures or organs being produced according to the present invention to re-activate metabolic activity in a nutrient containing environment after exposure to elevated temperatures during storage as compared to control spores. These temperatures may be higher than those of the heat treatment applied during production according to the invention to induce this tolerance to higher temperatures.

The method according to the present invention comprises a procedure comprising a heat treatment. Usually, the optimum growth temperature of fungi capable of producing spores ranges between 20 and 35° C. In order to provide a heat treatment according to the invention, the temperature should be in the range of between 5 and 30° C. above the optimum growth temperature or the temperature chosen for during fermentation of a specific fungus, preferably between 10 and 20° C. above said optimum growth temperature or fermentation temperature or any value in between this range. In other words, based on the above growth temperature, the temperature applied during the heat treatment is chosen to be between 37° C. and 65° C., preferably between 37° C. and 55° C., such as 38° C., 39° C., 40° C., 41° C., 42° C., 43° C., 44° C., 45° C., 46° C., 47° C., 48° C., 49° C., 50° C., 51° C., 52° C., 53° C. or 54° C., more preferably between 38° C. and 45° C. For example, for Metarhizium species, such as the species Metarhizium brunneum (formerly known as Metarhizium anisopliae) and/or Metarhizium acridum (formerly known as Metarhizium anisopliae var. acridum), the temperature of the heat treatment is preferably between 39° C. and 41° C.

Said heat treatment is effected for at least 10 min and may be extended to up to 48 hours. The exact duration of the heat treatment mainly depends on the fungal species and may be determined according to methods well-known in the art, such as the germination assays described herein which are applied after defined storage times. However, also the size of the spore containing vessel, such as the fermentation chamber, has an influence on the duration of the heat treatment. If a large chamber is used, elevating the temperature in order to effect the heat treatment may take longer than in small fermentation chambers. The skilled person based on his knowledge in fermentation practice is able to determine the duration of the heat treatment. Preferred times range from 30 minutes to 18 h and any value in between this range, such as 1 h, 2 h, 5 h, 10 h, 15 h, all depending on the fungal species and the size of the spore containing vessel, such as the fermentation chamber.

The treatment according to the invention may advantageously be applied during fermentation. During fermentation to produce dormant fungal structures or organs, such as fungal spores, the fungus is undergoing different growth phases (see Gowthaman et al., 2001), the final one of which is the maturation phase of the fungal spores. Depending on the species produced, said maturation phase may be reached at different points in time. In line with the morphological development of filamentous fungi after inoculation, the appropriate time point of applying the heat treatment needs to be chosen. The skilled person is aware of such species-specific differences and can adapt the point in time of the heat treatment accordingly. In connection with one embodiment of the present invention, the spores are subjected to said heat treatment during fermentation. That means, the fermentation batch containing spores at any stage of maturity is subjected to said heat treatment at any time during the maturation phase. In this respect, said heat treatment may be applied directly at the beginning of the maturation phase until shortly before harvest. Generally, the heat treatment is applied at the earliest when spore development has begun, which for the case of conidia means that conidiophores have formed and contain immature conidia at various stages. For example, said heat treatment may be applied at the earliest 11 days before harvest or less, preferably 10 days, more preferably 9 days or 8 days, even more preferably 7, 6, 5 or 4 days and most preferably 3 days before harvest or less. Alternatively, said heat treatment is applied when at least 50% of the dormant fungal structures or organs, such as spores are in the process of development, preferably when their development is completed. Methods of assaying when this point in time is reached are well-known to the skilled person, see e.g. Cascino et al., 1990 (Spore Yield and Microcycle Conidiation of Colletotrichum gloeosporioides in Liquid Culture. Appl Environ Microbiol. 56(8), pp: 2303-10). Again alternatively, said heat treatment is effected at any time after 50% of the total fermentation period has passed.

Alternatively, the dormant fungal structures or organs, such as spores may be subjected to said heat treatment after fermentation, i.e. during or after harvesting the dormant fungal structures or organs. If the dormant fungal structures or organs, such as spores are undergoing a drying step in order to prepare them for a commercial product, said heat treatment is preferably applied prior to said drying step.

Furthermore, after the heat treatment, the present method comprises subjecting said dormant fungal structures or organs, such as spores back to a lower temperature, which is either in the range of the preferred growth temperature of the respective fungus or is an even lower temperature, minimizing fungal activity and growth. The respective temperature range for this cooling step is usually between 0 and 36° C., preferably between 5 and 35° C., more preferably between 10 and 30° C. It is preferred that the dormant fungal structures or organs, after the heat treatment, reside at said temperature for at least 6 h, preferably at least 12 h, more preferably at least 24 h. In this regard, the present inventors revealed that there is a reverse correlation between the length of the cooling phase, which is believed to be a recovery phase for the dormant fungal structure or organs, and the temperature applied. That means the lower the temperature, the longer the recovery phase should be chosen and vice versa, so that the effect of increased viability and/or fitness is achieved. Choosing the appropriate recovery length and temperature lies well within the abilities of the person skilled in the art who knows that different fungal species have different temperature requirements. Exemplary setups include a recovery temperature of 10° C. and 4 days recovery time and a recovery temperature of 25° C. and 2 days recovery time.

The temperature difference between heat treatment and cooling period is chosen according to the requirement of the respective fungal strains but should generally be at least 5° C., more preferably at least 10° C. or at least 15° C. For example, for Metarhizium brunneum, said temperature difference is about 15° C.

In the course of the present invention, it was surprisingly found that a procedure comprising a heat treatment applied to developing or mature fungal spores, which represent the dormant, metabolically largely inactive form of filamentous fungi (see e.g. Novodvorska et al., 2016. Fungal Genetics and Biology 94, pages 23-31), followed by a cooling period results in an improved germination rate and efficiency as well as a higher metabolic activity and thus an increased storage stability as compared to spores produced without applying this procedure but otherwise under the same conditions. Without wishing to be bound to any scientific theory, Applicant believes that the heat treatment, although putting stress on the developing spores in the first place, makes them fitter to resist stress conditions later in time. Storage of spores which are normally dried and deprived of water is such stress condition to which the current treatment is believed to adapt the spores to a certain extent. Rangel et al., 2008 (Mycological research 112, pp: 1362-1372) disclose that increased stability would be reached in particular when a heat treatment is applied during the vegetative growth phase of the fungus, i.e. during mycelial growth, and not when spores are already formed. An important effect of the present method is also that applying a heat treatment to spores at any phase of maturation, in contrast to the treatment of mycelium before completion of spore formation/conidiogenesis in the spore forming organ or structure of the fungus, will not result in a loss of spore yield (see Example 4). It was further found that the fungal spores are advantageously subjected to a phase of recovery, in the form of a cooling period, after the heat treatment in order to develop the desired improved germination rate and efficiency.

As can be seen in the examples, a remarkable increase in viability was observed for fungal spores subjected to the method of the present invention as compared to control spores. Furthermore, no significant delay in infectivity or loss in efficacy could be observed for the examined fungal spores.

The method of the invention further comprises producing said dormant fungal structures or organs, such as spores by fermentation, i.e. fermentation of the underlying fungus. In this regard, suitable or preferred points in time of applying the heat treatment have been described elsewhere in this application.

The fungal microorganism producing spores and acting as biological control agent and/or plant growth promoter is cultivated or fermented according to methods known in the art or as described in this application on an appropriate substrate, e. g. by submerged fermentation or solid-state fermentation, e. g. using a device and method as disclosed in WO2005/012478 or WO1999/057239.

Although specific fungal propagules such as microsclerotia (see e.g. Jackson and Jaronski (2009), Production of microsclerotia of the fungal entomopathogen Metarhizium anisopliae and their potential for use as a biocontaol agent for soil-inhabiting insects; Mycological Research 113, pp. 842-850) may be produced by liquid fermentation techniques, it is preferred that the dormant structures or organs according to the present invention are produced by solid-state fermentation. Solid-state fermentation techniques are well known in the art (for an overview see Gowthaman et al., 2001. Appl Mycol Biotechnol (1), p. 305-352).

Dormant fungal structures or organs, such as fungal spores may be subjected to the procedure according to the present invention during or after fermentation. Application of the present procedure during fermentation is described elsewhere in this application. When applied after fermentation, it is preferred that the heat treatment is applied shortly after fermentation, e.g. up to 2 weeks after harvest, preferably, up to 1 week, more preferably up to four days or three days after harvest and preferably up to 24 h after harvest. In this case, the temperature range and other parameters are as described above for the heat treatment. The temperature within the cooling period may also encompass that present before applying said heat treatment or any storage temperature applied between harvest and heat treatment.

As mentioned above, after said heat treatment, the dormant fungal structures or organs, such as spores within the spore containing vessel, preferably the fermentation chamber, should be cooled down again to either the previous temperature or any temperature below the temperature of said heat treatment in order to provide the spores with the opportunity to recover from the heat stress applied.

When referring to temperatures for heat treatment or cooling period, said temperature always refers to the temperature applied to a vessel containing dormant fungal structures or organs, such as a spore containing vessel, e.g. the fermentation chamber or a container to store spores after harvest. Depending on the size of such vessel, it may take some time to arrive at a constant temperature in such vessel so that all dormant fungal structures or organs contained in said vessel are exposed to said temperature. The bigger the vessel the longer the respective temperature needs to be applied in order to arrive at the target temperature.

After fermentation, the dormant fungal structures or organs may be separated from the substrate. The substrate populated with the dormant fungal structures or organs is dried preferably before any separation step. The microorganism or its organs may be dried via e. g. freeze-drying, vacuum drying or spray drying after separation. Methods for preparing dried spores are well known in the art and include fluidized bed drying, spray drying, vacuum drying and lyophilization. Conidia may be dried in 2 steps: For condia produced by solid-state fermentation first the conidia covered culture substrate is dried before harvesting the conidia from the dried culture substrate thereby obtaining a pure conidia powder. Then the conidia powder is dried further using vacuum drying or lyophilization before storing or formulating it.

In a preferred embodiment of the method of the present invention wherein said procedure is applied after fermentation, the heat treatment comprises an elevation of the temperature as described above, preferably after separation from the fermentation substrate.

Said dormant fungal structures or organs, such as fungal spores are preferably dormant fungal structures or organs, such as spores of at least one filamentous fungus.

The term “at least one” in connection with the present invention relates to one or more of a kind, such as (at least) two, (at least) three or even (at least) four.

Filamentous fungi, as the skilled person is well aware, are distinguished from yeasts because of their tendency to grow in a multicellular, filamentous form under most conditions, in contrast to the primarily unicellular growth of oval or elliptical yeast cells.

Said at least one filamentous fungus may be any fungus exerting a positive effect on plants such as a plant protective or plant growth promoting effect. Accordingly, said fungus may be an entomopathogenic fungus, a nematophagous fungus, a plant growth promoting fungus, a fungus active against plant pathogens such as bacteria or fungal plant pathogens, or a fungus with herbicidal action.

Exemplary species of plant growth/plant health supporting, promoting or stimulating fungi are E2.1 Talaromyces flavus, in particular strain V117b; E2.2 Trichoderma atroviride, in particular strain no. V08/002387, strain no. NMI No. V08/002388, strain no. NMI No. V08/002389, strain no. NMI No. V08/002390, strain LC52 (e.g. Sentinel from Agrimm Technologies Limited) and/or strain LUI32 (e.g. Tenet from Agrimm Technologies Limited); E2.3 Trichoderma harzianum, in particular strain ITEM 908 (e.g. Trianum-P from Koppert); E2.4 Myrothecium verrucaria, in particular strain AARC-0255 (e.g. DiTera™ from Valent Biosciences); E2.5 Penicillium bilaii, in particular strain ATCC 22348 and/or strain ATCC20851 (e.g. Jumpstart® from Novozymes); E2.6 Pythium oligandrum, in particular strain DV74 or M1 (ATCC 38472; e.g. Polyversum from Bioprepraty, CZ); E2.7 Rhizopogon amylopogon (e.g. Myco-Sol from Helena Chemical Company); E2.8 Rhizopogon fulvigleba (e.g. Myco-Sol from Helena Chemical Company); E2.9 Trichoderma harzianum, in particular strain TSTh20, strain KD (e.g. Eco-T from Plant Health Products, SZ) or strain 1295-22; E2.10 Trichoderma koningii; E2.11 Glomus aggregatum; E2.12 Glomus clarum; E2.13 Glomus deserticola; E2.14 Glomus etunicatum; E2.15 Glomus intraradices; E2.16 Glomus monosporum; E2.17 Glomus mosseae; E2.18 Laccaria bicolor; E2.19 Rhizopogon luteolus; E2.20 Rhizopogon tinctorus; E2.21 Rhizopogon villosulus; E2.22 Scleroderma cepa; E2.23 Suillus granulatus; E2.24 Suillus punctatapies; E2.25 Trichoderma virens, in particular strain GL-21; and E2.26 Verticillium albo-atrum (formerly V. dahliae), in particular strain WCS850 (CBS 276.92; e.g. Dutch Trig from Tree Care Innovations).

In a more preferred embodiment, fungal strains having a beneficial effect on plant health and/or growth are selected from Talaromyces flavus, strain VII7b; Trichoderma harzianum, strain KD (e.g. Eco-T from Plant Health Products, SZ); Myrothecium verrucaria, strain AARC-0255 (available as DiTera™ from Valent Biosciences); Penicillium bilaii, strain ATCC 22348 (available as JumpStart® from Novozymes or as PB-50 PROVIDE from Philom Bios Inc., Saskatoon, Saskatchewan); and Pythium oligandrum, strain DV74 or M1 (ATCC 38472) (available as Polyversum from Bioprepraty, CZ).

In an even more preferred embodiment, fungal strains having a beneficial effect on plant health and/or growth are selected from Penicillium bilaii, in particular strain ATCC 22348 (available as JumpStart® from Novozymes), Trichoderma harzianum, strain KD (e.g. Eco-T from Plant Health Products, SZ) and Penicillium bilaii strain ATCC 22348 or strain 20851.

Bactericidally active fungi are e.g.: A2.2 Aureobasidium pullulans, in particular blastospores of strain DSM14940; A2.3 Aureobasidium pullulans, in particular blastospores of strain DSM 14941; A2.4 Aureobasidium pullulans, in particular mixtures of blastospores of strains DSM14940 and DSM14941; A2.9 Scleroderma citrinum.

Fungi active against fungal pathogens are e.g. B2.1 Coniothyrium minitans, in particular strain CON/M/91-8 (Accession No. DSM-9660; e.g. Contans® from Bayer CropScience Biologics GmbH); B2.2 Metschnikowia fructicola, in particular strain NRRL Y-30752; B2.3 Microsphaeropsis ochracea; B2.4 Muscodor albus, in particular strain QST 20799 (Accession No. NRRL 30547); B2.5 Trichoderma harzianum rifai, in particular strain KRL-AG2 (also known as strain T-22, /ATCC 208479, e.g. PLANTSHIELD T-22G, Rootshield®, and TurfShield from BioWorks, US) and strain T39 (e.g. Trichodex® from Makhteshim, US); B2.6 Arthrobotrys dactyloides; B2.7 Arthrobotrys oligospora; B2.8 Arthrobotrys superba; B2.9 Aspergillus flavus, in particular strain NRRL 21882 (e.g. Afla-Guard® from Syngenta) or strain AF36 (e.g. AF36 from Arizona Cotton Research and Protection Council, US); B2.10 Gliocladium roseum, in particular strain 321U from Adjuvants Plus, strain ACM941 as disclosed in Xue (Efficacy of Clonostachys rosea strain ACM941 and fungicide seed treatments for controlling the root rot complex of field pea, Can Jour Plant Sci 83(3): 519-524), strain IK726 (Jensen D F, et al. Development of a biocontrol agent for plant disease control with special emphasis on the near commercial fungal antagonist Clonostachys rosea strain ‘IK726’; Australas Plant Pathol. 2007; 36:95-101), strain 88-710 (WO2007/107000), strain CR7 (WO2015/035504) or strains CRrO, CRM and CRr2 disclosed in WO2017109802; B2.11 Phlebiopsis (or Phlebia or Peniophora) gigantea, in particular strain VRA 1835 (ATCC 90304), strain VRA 1984 (DSM16201), strain VRA 1985 (DSM16202), strain VRA 1986 (DSM16203), strain FOC PG B20/5 (IMI390096), strain FOC PG SP log 6 (IMI390097), strain FOC PG SP log 5 (IMI390098), strain FOC PG BU3 (IMI390099), strain FOC PG BU4 (IMI390100), strain FOC PG 410.3 (IMI390101), strain FOC PG 97/1062/116/1.1 (IMI390102), strain FOC PG B22/SP1287/3.1 (IMI390103), strain FOC PG SH1 (IMI390104) and/or strain FOC PG B22/SP1190/3.2 (IMI390105) (Phlebiopsis products are e.g. Rotstop® from Verdera and FIN, PG-Agromaster®, PG-Fungler®, PG-IBL®, PG-Poszwald® and Rotex® from e-nema, DE); B2.12 Pythium oligandrum, in particular strain DV74 or M1 (ATCC 38472; e.g. Polyversum from Bioprepraty, CZ); B2.13 Scleroderma citrinum; B2.14 Talaromyces flavus, in particular strain V117b; B2.15 Trichoderma asperellum, in particular strain ICC 012 from Isagro or strain SKT-1 (e.g. ECO-HOPE® from Kumiai Chemical Industry), strain T34 (e.g. T34 Biocontrol by Biocontrol Technologies S.L., ES); B2.16 Trichoderma atroviride, in particular strain CNCM 1-1237 (e.g. Esquive® WP from Agrauxine, FR), strain SC1 described in International Application No. PCT/IT2008/000196), strain 77B (T77 from Andermatt Biocontrol), strain no. V08/002387, strain NMI no. V08/002388, strain NMI no. V08/002389, strain NMI no. V08/002390, strain LC52 (e.g. Sentinel by Agrimm Technologies Limited), strain ATCC 20476 (IMI 206040), strain T11 (IMI352941/CECT20498), strain SKT-1 (FERM P-16510), strain SKT-2 (FERM P-16511), strain SKT-3 (FERM P-17021); B2.17 Trichoderma harmatum; B2.18 Trichoderma harzianum, in particular, strain KD (e.g. Trichoplus from Biological Control Products, SA (acquired by Becker Underwood)), strain ITEM 908 (e.g. Trianum-P from Koppert), strain TH35 (e.g. Root-Pro by Mycontrol), strain DB 103 (e.g. T-Gro 7456 by Dagutat Biolab); B2.19 Trichoderma virens (also known as Gliocladium virens), in particular strain GL-21 (e.g. SoilGard 12G by Certis, US); B2.20 Trichoderma viride, in particular strain TV1 (e.g. Trianum-P by Koppert), strain B35 (Piety et al., 1993, Zesz. Nauk. A R w Szczecinie 161: 125-137); B2.21 Ampelomyces quisqualis, in particular strain AQ 10 (e.g. AQ 10® by IntrachemBio Italia); B2.22 Arkansas fungus 18, ARF; B2.23 Aureobasidium pullulans, in particular blastospores of strain DSM14940, blastospores of strain DSM 14941 or mixtures of blastospores of strains DSM14940 and DSM 14941 (e.g. Botector® by bio-ferm, CH); B2.24 Chaetomium cupreum (e.g. BIOKUPRUM™ by AgriLife); B2.25 Chaetomium globosum (e.g. Rivadiom by Rivale); B2.26 Cladosporium cladosporioides, in particular strain H39 (by Stichting Dienst Landbouwkundig Onderzoek); B2.27 Dactylaria candida; B2.28 Dilophosphora alopecuri (e.g. Twist Fungus); B2.29 Fusarium oxysporum, in particular strain Fo47 (e.g. Fusaclean by Natural Plant Protection); B2.30 Gliocladium catenulatum (Synonym: Clonostachys rosea f. catenulate), in particular strain J1446 (e.g. Prestop® by AgBio Inc. and also e.g. Primastop® by Kemira Agro Oy), strain IK726, strain 88-710 (WO2007/107000), strain CR7 (WO2015/035504); B2.31 Lecanicillium lecanii (formerly known as Verticillium lecanii), in particular conidia of strain KV01 (e.g. Vertalec® by Koppert/Arysta); B2.32 Penicillium vermiculatum; B2.33 Trichoderma gamsii (formerly T. viride), in particular strain ICC080 (IMI CC 392151 CABI, e.g. BioDerma by AGROBIOSOL DE MEXICO, S.A. DE C.V.); B2.34 Trichoderma polysporum, in particular strain IMI 206039 (e.g. Binab TF WP by BINAB Bio-Innovation AB, Sweden); B2.35 Trichoderma stromaticum (e.g. Tricovab by Ceplac, Brazil); B2.36 Tsukamurella paurometabola, in particular strain C-924 (e.g. HeberNem®); B2.37 Ulocladium oudemansii, in particular strain HRU3 (e.g. Botry-Zen® by Botry-Zen Ltd, NZ); B2.38 Verticillium albo-atrum (formerly V. dahliae), in particular strain WCS850 (CBS 276.92; e.g. Dutch Trig by Tree Care Innovations); B2.39 Muscodor roseus, in particular strain A3-5 (Accession No. NRRL 30548); B2.40 Verticillium chlamydosporium; B2.41 mixtures of Trichoderma asperellum strain ICC 012 and Trichoderma gamsii strain ICC 080 (product known as e.g. BIO-TAM™ from Bayer CropScience LP, US) and B2.42 Simplicillium lanosoniveum.

In a preferred embodiment, the biological control agent having fungicidal activity is selected from Coniothyrium minitans, in particular strain CON/M/91-8 (Accession No. DSM-9660) (available as Contans® from Bayer CropScience Biologics GmbH); Microsphaeropsis ochracea strain P130A (ATCC 74412); Aspergillus flavus, strain NRRL 21882 (available as Afla-Guard® from Syngenta) and strain AF36 (available as AF36 from Arizona Cotton Research and Protection Council, US); Gliocladium roseum, strain 321U from Adjuvants Plus, strain IK726, strain 88-710 (WO2007/107000), strain CR7 (WO2015/035504); Phlebiopsis (or Phlebia or Peniophora) gigantea, in particular the strains VRA 1835 (ATCC 90304), VRA 1984 (DSM16201), VRA 1985 (DSM16202), VRA 1986 (DSM16203), FOC PG B20/5 (IMI390096), FOC PG SP log 6 (IMI390097), FOC PG SP log 5 (IMI390098), FOC PG BU3 (IMI390099), FOC PG BU4 (IMI390100), FOC PG 410.3 (IMI390101), FOC PG 97/1062/116/1.1 (IMI390102), FOC PG B22/SP1287/3.1 (IMI390103), FOC PG SH1 (IMI390104), FOC PG B22/SP1190/3.2 (IMI390105) (available as Rotstop® from Verdera and FIN, PG-Agromaster®, PG-Fungler®, PG-IBL®, PG-Poszwald®, and Rotex® from e-nema, DE); Pythium oligandrum, strain DV74 or M1 (ATCC 38472) (available as Polyversum from Bioprepraty, CZ); Scleroderma citrinum; Talaromyces flavus, strain VII7b; Ampelomyces quisqualis, in particular strain AQ 10 (available as AQ 100 by IntrachemBio Italia); Gliocladium catenulatum (Synonym: Clonostachys rosea f. catenulate) strain J1446 (available as Prestop® by AgBio Inc. and also available as Primastop® by Verdera Oy), Cladosporium cladosporioides, e. g. strain H39 (by Stichting Dienst Landbouwkundig Onderzoek) and Simplicillium lanosoniveum.

In a more preferred embodiment, the biological control agent having fungicidal activity is selected from Coniothyrium minitans, in particular strain CON/M/91-8 (Accession No. DSM-9660) (available as Contans® from Prophyta, DE); Talaromyces flavus, strain VII7b; Cladosporium cladosporioides, e. g. strain H39 (by Stichting Dienst Landbouwkundig Onderzoek); Gliocladium roseum, strain 321U from Adjuvants Plus, strain IK726, strain 88-710 (WO2007/107000), strain CR7 (WO2015/035504); and Simplicillium lanosoniveum.

Nematicidally active fungal species include D2.1 Muscodor albus, in particular strain QST 20799 (Accession No. NRRL 30547); D2.2 Muscodor roseus, in particular strain A3-5 (Accession No. NRRL 30548); D2.3 Paecilomyces lilacinus (also known as Purpureocillium lilacinum), in particular P. lilacinus strain 251 (AGAL 89/030550; e.g. BioAct from Bayer CropScience Biologics GmbH); D2.4 Trichoderma koningii; D2.5 Harposporium anguillullae; D2.6 Hirsutella minnesotensis; D2.7 Monacrosporium cionopagum; D2.8 Monacrosporium psychrophilum; D2.9 Myrothecium verrucaria, in particular strain AARC-0255 (e.g. DiTera™ by Valent Biosciences); D2.10 Paecilomyces variotii, strain Q-09 (e.g. Nemaquim® from Quimia, MX); D2.11 Stagonospora phaseoli (e.g. from Syngenta); D2.12 Trichoderma lignorum, in particular strain TL-0601 (e.g. Mycotric from Futureco Bioscience, ES); D2.13 Fusarium solani, strain Fs5; D2.14 Hirsutella rhossiliensis; D2.15 Monacrosporium drechsleri; D2.16 Monacrosporium gephyropagum; D2.17 Nematoctonus geogenius; D2.18 Nematoctonus leiosporus; D2.19 Neocosmospora vasinfecta; D2.20 Paraglomus sp, in particular Paraglomus brasilianum; D2.21 Pochonia chlamydosporia (also known as Vercillium chlamydosporium), in particular var. catenulata (IMI SD 187; e.g. KlamiC from The National Center of Animal and Plant Health (CENSA), CU); D2.22 Stagonospora heteroderae; D2.23 Meristacrum asterospermum, D2.24 Duddingtonia flagrans.

In a more preferred embodiment, fungal strains with nematicidal effect are selected from Paecilomyces lilacinus, in particular spores of P. lilacinus strain 251 (AGAL 89/030550) (available as BioAct from Bayer CropScience Biologics GmbH); Harposporium anguillullae; Hirsutella minnesotensis; Monacrosporium cionopagum; Monacrosporium psychrophilum; Myrothecium verrucaria, strain AARC-0255 (available as DiTera™ by Valent Biosciences); Paecilomyces variotii; Stagonospora phaseoli (commercially available from Syngenta); and Duddingtonia flagrans.

In an even more preferred embodiment, fungal strains with nematicidal effect are selected from Paecilomyces lilacinus, in particular spores of P. lilacinus strain 251 (AGAL 89/030550) (available as BioAct from Bayer CropScience Biologics GmbH); and Duddingtonia flagrans.

Fungi active against insects (entomopathogenic fungi) include C2.1 Muscodor albus, in particular strain QST 20799 (Accession No. NRRL 30547); C2.2 Muscodor roseus in particular strain A3-5 (Accession No. NRRL 30548); C2.3 Beauveria bassiana, in particular strain ATCC 74040 (e.g. Naturalis® from CBC Europe, Italy; Contego BB from Biological Solutions Ltd.; Racer from AgriLife); strain GHA (Accession No. ATCC74250; e.g. BotaniGuard Es and Mycontrol-O from Laverlam International Corporation); strain ATP02 (Accession No. DSM 24665); strain PPRI 5339 (e.g. BroadBand™ from BASF); strain PPRI 7315, strain R444 (e.g. Bb-Protec from Andermatt Biocontrol), strains IL197, IL12, IL236, IL10, IL131, IL116 (all referenced in Jaronski, 2007. Use of Entomopathogenic Fungi in Biological Pest Management, 2007: ISBN: 978-81-308-0192-6), strain Bv025 (see e.g. Garcia et al. 2006. Manejo Integrado de Plagas y Agroecologia (Costa Rica) No. 77); strain BaGPK; strain ICPE 279, strain CG 716 (e.g. BoveMax® from Novozymes); C2.4 Hirsutella citriformis; C2.5 Hirsutella thompsonii (e.g. Mycohit and ABTEC from Agro Bio-tech Research Centre, IN); C2.6 Lecanicillium lecanii (formerly known as Verticillium lecanii), in particular conidia of strain KV01 (e.g. Mycotal® and Vertalec® from Koppert/Arysta); C2.7 Lecanicillium lecanii (formerly known as Verticillium lecanii), in particular conidia of strain DAOM198499; C2.8 Lecanicillium lecanii (formerly known as Verticillium lecanii), in particular conidia of strain DAOM216596; C2.9 Lecanicillium muscarium (formerly Verticillium lecanii), in particular strain VE 6/CABI(=IMI) 268317/CBS102071/ARSEF5128 (e.g. Mycotal from Koppert); C2.10 Metarhizium acridum, e.g. ARSEF324 from GreenGuard by BASF or isolate IMI 330189 (ARSEF7486; e.g. Green Muscle by Biological Control Products); C2.11 Metarhizium anisopliae complex, e.g. strain Cb 15 (e.g. ATTRACAP® from BIOCARE); strain ESALQ 1037 (e.g. from Metarril® SP Organic), strain E-9 (e.g. from Metarril® SP Organic), strain M206077, strain C4-B (NRRL 30905), strain ESC1, strain 15013-1 (NRRL 67073), strain 3213-1 (NRRL 67074), strain C20091, strain C20092, strain F52 (DSM3884/ATCC 90448; e.g. BIO 1020 by Bayer CropScience and also e.g. Met52 by Novozymes) or strain ICIPE 78; C2.15 Metarhizium robertsii 23013-3 (NRRL 67075); C2.13 Nomuraea rileyi; C2.14 Paecilomyces fumosoroseus (new: Isaria fumosorosea), strain apopka 97 (e.g. PreFeRal® WG from Biobest), strain IF-BDC01, strain FE 9901 (e.g. NoFly® from Natural Industries Inc., a Novozymes company); C2.15 Aschersonia aleyrodis; C2.16 Beauveria brongniartii (e.g. Beaupro from Andermatt Biocontrol AG); C2.17 Conidiobolus obscurus; C2.18 Entomophthora virulenta (e.g. Vektor from Ecomic); C2.19 Lagenidium giganteum; C2.20 Metarhizium flavoviride; C2.21 Mucor haemelis (e.g. BioAvard from Indore Biotech Inputs & Research); C2.22 Pandora delphacis; C2.23 Sporothrix insectorum (e.g. Sporothrix Es from Biocerto, BR); C2.24 Zoophtora radicans.

In a preferred embodiment, fungal strains having an insecticidal effect may be selected from Beauveria bassiana, strain ATCC 74040 (available as Naturalis® from Intrachem Bio Italia), strain GHA (Accession No. ATCC74250) (available as BotaniGuard Es and Mycontrol-O from Laverlam International Corporation), strain ATP02 (Accession No. DSM 24665), strain CG 716 (available as BoveMax® from Novozymes), strains IL197, IL12, IL236, IL10, IL131, IL116 (all referenced in Jaronski, 2007. Use of Entomopathogenic Fungi in Biological Pest Management, 2007: ISBN: 978-81-308-0192-6), strain Bv025 (see e.g. Garcia et al. 2006. Manejo Integrado de Plagas y Agroecologia (Costa Rica) No. 77), and strain PPRI 5339 (e.g. BroadBand™ from BASF); Hirsutella citriformis; Hirsutella thompsonii (with some strains available as Mycohit and ABTEC from Agro Bio-tech Research Centre, IN); Lecanicillium lecanii (formerly known as Verticillium lecanii) conidia of strain KV01 (available as Mycotal® and Vertalec® from Koppert/Arysta); Lecanicillium lecanii (formerly known as Verticillium lecanii) conidia of strain DAOM198499; Lecanicillium lecanii (formerly known as Verticillium lecanii) conidia of strain DAOM216596; Lecanicillium muscarium (formerly Verticillium lecanii), strain VE 6/CABI(=IMI) 268317/CBS102071/ARSEF5128; Metarhizium brunneum, strain F52 (DSM3884/ATCC 90448) (available as Met52 by Novozymes); M. acridum (ARSEF324 available as GreenGuard by BASF); M. acridum isolate IMI 330189 (ARSEF7486) (available as Green Muscle by Biological Control Products); Metarhizium brunneum strain Cb 15 (e.g. ATTRACAP® from BIOCARE); Nomuraea rileyi; Paecilomyces fumosoroseus (new: Isaria fumosorosea), strain apopka 97 (available as PreFeRal® WG from Biobest); Paecilomyces fumosoroseus (new: Isaria fumosorosea) strain FE 9901 (available as NoFly® from Natural Industries Inc., a Novozymes company); and Beauveria brongniartii (e.g. Beaupro from Andermatt Biocontrol AG).

In a more preferred embodiment, fungal strains having an insecticidal effect are selected from Beauveria bassiana, in particular strain ATCC 74040 (available as Naturalis® from Intrachem Bio Italia), strain GHA (Accession No. ATCC74250) (available as BotaniGuard Es and Mycontrol-O from Laverlam International Corporation), strain ATP02 (Accession No. DSM 24665), strain CG 716 (available as BoveMax® from Novozymes), strains IL197, IL12, IL236, IL10, IL131, IL116 (all referenced in Jaronski, 2007. Use of Entomopathogenic Fungi in Biological Pest Management, 2007: ISBN: 978-81-308-0192-6), strain Bv025 (see e.g. Garcia et al. 2006. Manejo Integrado de Plagas y Agroecologia (Costa Rica) No. 77); Paecilomyces fumosoroseus (new: Isaria fumosorosea), strain apopka 97 (available as PreFeRal® WG from Biobest) and strain FE 9901 (e.g. NoFly® from Natural Industries Inc., a Novozymes company); Lecanicillium lecanii (formerly known as Verticillium lecanii), conidia of strain KV01 (available as Mycotal® and Vertalec® from Koppert/Arysta), conidia of strain DAOM198499 or conidia of strain DAOM216596; Metarhizium brunneum, strain F52 (DSM3884/ATCC 90448) (available as Met52 by Novozymes); Metarhizium acridum, strain ARSEF324; Nomuraea rileyi; Lecanicillium muscarium (formerly Verticillium lecanii), strain VE 6/CABI(=IMI) 268317/CBS102071/ARSEF5128; and Beauveria brongniartii (e.g. Beaupro from Andermatt Biocontrol AG).

It is even more preferred that said fungus is a strain of the genus Metarhizium spp. The genus Metahrizium comprises several species some of which have recently been re-classified (for an overview, see Bischoff et al., 2009; Mycologia 101 (4): 512-530). Members of the genus Metarhizium comprise M. pingshaense, M. anisopliae, M. robertsii, M. brunneum (these four are also referred to as Metarhizium anisopliae complex), M. acridum, M. majus, M. guizouense, M. lepidiotae and M. globosum. Of these, M. anisopliae, M. robertsii, M. brunneum and M. acridum are even more preferred, whereas those of M. brunneum and M. acridum are most preferred. Exemplary strains belonging to Metarhizium spp. which are also especially preferred are Metarhizium acridum ARSEF324 (product GreenGuard by BASF) or isolate IMI 330189 (ARSEF7486; e.g. Green Muscle by Biological Control Products); Metarhizium brunneum strain Cb 15 (e.g. ATTRACAP® from BIOCARE), or strain F52 (DSM3884/ATCC 90448; e.g. BIO 1020 by Bayer CropScience and also e.g. Met52 by Novozymes); Metarhizium anisopliae complex strains ESALQ 1037 or strain ESALQ E-9 (both from Metarril® WP Organic), strain M206077, strain C4-B (NRRL 30905), strain ESC1, strain 15013-1 (NRRL 67073), strain 3213-1 (NRRL 67074), strain C20091, strain C20092, or strain ICIPE 78. Most preferred are isolate F52 (a.k.a. Met52) which primarily infects beetle larvae and which was originally developed for control of Otiorhynchus sulcatus. and ARSEF324 which is commercially used in locust control. Commercial products based on the F52 isolate are subcultures of the individual isolate F52 and are represented in several culture collections including: Julius Kuhn-Institute for Biological Control (previously the BBA), Darmstadt, Germany: [as M.a. 43]; HRI, UK: [275-86 (acronyms V275 or KVL 275)]; KVL Denmark [KVL 99-112 (Ma 275 or V 275)]; Bayer, Germany [DSM 3884]; ATCC, USA [ATCC 90448]; USDA, Ithaca, USA [ARSEF 1095]. Granular and emulsifiable concentrate formulations based on this isolate have been developed by several companies and registered in the EU and North America (US and Canada) for use against black vine weevil in nursery ornamentals and soft fruit, other Coleoptera, western flower thrips in greenhouse ornamentals and chinch bugs in turf.

Only few fungi with selective herbicidal activity are known, such as F2.1 Phoma macrostroma, in particular strain 94-44B (e.g. Phoma H and Phoma P by Scotts, US); F2.2 Sclerotinia minor, in particular strain IMI 344141 (e.g. Sarritor by Agrium Advanced Technologies); F2.3 Colletotrichum gloeosporioides, in particular strain ATCC 20358 (e.g. Collego (also known as LockDown) by Agricultural Research Initiatives); F2.4 Stagonospora atriplicis; or F2.5 Fusarium oxysporum, different strains of which are active against different plant species, e.g. the weed Striga hermonthica (Fusarium oxysproum formae specialis strigae).

In another aspect, the present invention relates to a fungal spore composition having an improved germination rate and/or germination efficiency, said composition comprising a) a carrier; and b) fungal spores subjected to a procedure comprising a heat treatment at a temperature of between 37° C. and 65° C. followed by a cooling period at a temperature of between 0° C. and 36° C., wherein 1 week, preferably 2 weeks after finishing said procedure said fungal spores exhibit an improved germination rate and/or germination efficiency as compared to fungal spores not subjected to the treatment according to the invention.

All preferred embodiments described in connection with the method of the invention are equally applicable to this and other aspects of the present invention, unless stated otherwise.

In principle, it is possible to use all suitable carriers which may be liquid (also called solvent) or solid. Useful carriers include especially: for example ammonium salts and ground natural minerals such as kaolins, clays, talc, chalk, quartz, attapulgite, montmorillonite or diatomaceous earth, and ground synthetic materials such as finely divided silica, alumina and natural or synthetic silicates, resins, waxes and/or solid fertilizers. Mixtures of such carriers can likewise be used. Useful carriers for granules include for example crushed and fractionated natural rocks such as calcite, marble, pumice, sepiolite, dolomite, and synthetic granules of inorganic and organic meals, and also granules of organic material such as sawdust, paper, coconut shells, corn cobs and tobacco stalks. Particularly suitable carriers for fungal spores include solid carriers such as peat, wheat, wheat chaff, ground wheat straw, bran, vermiculite, sugars such as maltose, glucose, lactose, dextrose and trehalose; cellulose, starch, soil (pasteurized or unpasteurized), gypsum, talc, clays (e.g. kaolin, bentonite, montmorillonite), and silica gels.

In a preferred embodiment, said composition is a storage-stable composition comprising dormant fungal structures or organs, such as a fungal spore composition, wherein said dormant fungal structures or organs, preferably fungal spores have been produced according to the method of the invention.

In a different aspect, the present invention relates to a solid-state fermentation method comprising, during fermentation and in the presence of dormant fungal structures or organs, such as fungal spores, increasing the temperature in the fermentation chamber to between 37 and 65° C., followed by cooling down said fermentation chamber to a temperature of between 0 and 36° C.

In yet another aspect, the present invention relates to a method for producing a composition comprising dormant fungal structures or organs, preferably a fungal spore composition according to the invention as described above, comprising mixing dormant fungal structures or organs, such as fungal spores subjected to a procedure comprising a heat treatment of between 37° C. and 65° C. followed by a cooling period at a temperature of between 0° C. and 36° C., with a carrier, wherein 1 week, preferably 2 weeks after finishing said cooling period said dormant fungal structures or organs, such as fungal spores exhibit an improved germination rate and/or germination efficiency as compared to dormant fungal structures or organs, such as fungal spores not subjected to said procedure.

Furthermore, the present invention relates to a method for treating a plant or plant part comprising contacting said plant or plant part with a composition comprising dormant fungal structures or organs, preferably a fungal spore composition according to the invention, dormant fungal structures or organs, such as fungal spores produced by the method of the invention or the composition comprising dormant fungal structures or organs, preferably the fungal spore composition produced by the method according to the invention.

All plants and plant parts can be treated in accordance with the invention. Here, plants are to be understood to mean all plants and plant parts such as wanted and unwanted wild plants or crop plants (including naturally occurring crop plants), for example cereals (wheat, rice, triticale, barley, rye, oats), maize, soya bean, potato, sugar beet, sugar cane, tomatoes, pepper, cucumber, melon, carrot, watermelon, onion, lettuce, spinach, leek, beans, Brassica oleracea (e.g. cabbage) and other vegetable species, cotton, tobacco, oilseed rape, and also fruit plants (with the fruits apples, pears, citrus fruits and grapevines). Crop plants can be plants which can be obtained by conventional breeding and optimization methods or by biotechnological and genetic engineering methods or combinations of these methods, including the transgenic plants and including the plant varieties which can or cannot be protected by varietal property rights. Plants should be understood to mean all developmental stages, such as seeds, seedlings, young (immature) plants up to mature plants. Plant parts should be understood to mean all parts and organs of the plants above and below ground, such as shoot, leaf, flower and root, examples given being leaves, needles, stalks, stems, flowers, fruit bodies, fruits and seeds, and also tubers, roots and rhizomes. Parts of plants also include harvested plants or harvested plant parts and vegetative and generative propagation material, for example seedlings, tubers, rhizomes, cuttings and seeds.

Treatment according to the invention of the plants and plant parts with the dormant fungal structures or organs, preferably fungal spores, or the composition comprising dormant fungal structures or organs, such as the fungal spore composition according to the invention is carried out directly or by allowing the compounds to act on the surroundings, environment or storage space by the customary treatment methods, for example by immersion, spraying, evaporation, fogging, scattering, painting on, injection and, in the case of propagation material, in particular in the case of seeds, also by applying one or more coats.

As already mentioned above, it is possible to treat all plants and their parts according to the invention. In a preferred embodiment, wild plant species and plant cultivars, or those obtained by conventional biological breeding methods, such as crossing or protoplast fusion, and also parts thereof, are treated. In a further preferred embodiment, transgenic plants and plant cultivars obtained by genetic engineering methods, if appropriate in combination with conventional methods (genetically modified organisms), and parts thereof are treated. The term “parts” or “parts of plants” or “plant parts” has been explained above. The invention is used with particular preference to treat plants of the respective commercially customary cultivars or those that are in use. Plant cultivars are to be understood as meaning plants having new properties (“traits”) and which have been obtained by conventional breeding, by mutagenesis or by recombinant DNA techniques. They can be cultivars, varieties, bio- or genotypes.

Transgenic plants or plant cultivars (those obtained by genetic engineering) which are to be treated with preference in accordance with the invention include all plants which, through the genetic modification, received genetic material which imparts particular advantageous useful properties (“traits”) to these plants. Examples of such properties are better plant growth, increased tolerance to high or low temperatures, increased tolerance to drought or to levels of water or soil salinity, enhanced flowering performance, easier harvesting, accelerated ripening, higher yields, higher quality and/or a higher nutritional value of the harvested products, better storage life and/or processability of the harvested products. Further and particularly emphasized examples of such properties are increased resistance of the plants against animal and microbial pests, such as against insects, arachnids, nematodes, mites, slugs and snails owing, for example, to toxins formed in the plants, in particular those formed in the plants by the genetic material from Bacillus thuringiensis (for example by the genes CryIA(a), CryIA(b), CryIA(c), CryIIA, CryIIIA, CryIIIB2, Cry9c Cry2Ab, Cry3Bb and CryIF and also combinations thereof), furthermore increased resistance of the plants against phytopathogenic fungi, bacteria and/or viruses owing, for example, to systemic acquired resistance (SAR), systemin, phytoalexins, elicitors and also resistance genes and correspondingly expressed proteins and toxins, and also increased tolerance of the plants to certain herbicidally active compounds, for example imidazolinones, sulphonylureas, glyphosate or phosphinothricin (for example the “PAT” gene). The genes which impart the desired traits in question may also be present in combinations with one another in the transgenic plants. Examples of transgenic plants which may be mentioned are the important crop plants, such as cereals (wheat, rice, triticale, barley, rye, oats), maize, soya beans, potatoes, sugar beet, sugar cane, tomatoes, peas and other types of vegetable, cotton, tobacco, oilseed rape and also fruit plants (with the fruits apples, pears, citrus fruits and grapes), with particular emphasis being given to maize, soya beans, wheat, rice, potatoes, cotton, sugar cane, tobacco and oilseed rape. Traits which are particularly emphasized are the increased resistance of the plants to insects, arachnids, nematodes and slugs and snails.

In another aspect, the present invention relates to the use of a procedure comprising a heat treatment at between 37° C. and 65° C. followed by a cooling period at between 0° C. and 36° C., all as described elsewhere in this application for improving the germination rate of dormant fungal structures or organs, such as fungal spores.

The following examples illustrate the invention without limiting it.

### EXAMPLE 1: MATERIALS AND METHODS

### Determination of the Germination Rate

To determine the germination rate of fungal spores, water-based spore suspensions were generated. For example, conidia were harvested from agar plates by flooding the plate with water supplemented with 0.1% of the detergent Neo-wett (Kwizda Agro) and the spores scraped off using cell scrapers. These suspensions were passed through 50 μm strainers to remove fungal hyphae. Alternatively, spores were produced by solid state fermentation and harvested as described below. All harvested spores were spread on PDA (potato dextrose agar) plates and incubated at 25° C. for 1 to 2 days until germination was monitored microscopically.

### Determination of Metabolic Activity

The metabolic activity of fungal spores in a nutrient containing environment was determined using the Presto Blue Cell Viability® reagent (Invitrogen). This resazurin-based assay can monitor in a linear fashion the metabolic activity of cell populations (Hamalainen-Laanaya and Orloff, 2012. Analysis of cell viability using time-dependent increase in fluorescence intensity. Analytical Biochemistry 429 (1), pp: 32-38). To measure the activity of fungal spores, spore suspensions were generated as described above, and serial 1:2 dilutions of spores were subjected to PDB (potato dextrose broth) containing 10% Presto Blue Cell Viability® reagent. This suspension was incubated 16 to 48 hours at 25° C. before fluorescence was measured according to the manufactures recommendation. The serial dilutions were included to make sure that the metabolic activity was monitored in the linear range of the Presto Blue Cell Viability® assay. The arbitrary units of the fluorescence measurements were normalized to the number of spores in each sample. Spores were counted by cell counting methods well known in the art such as haemocytometer.

### Determination of the Temperature Tolerance

To determine the tolerance of fungal spores to elevated temperatures, spore suspensions were incubated at 44° C. for 0 min (control), 5 min, 10 min, 15 min, 20 min, 30 min and 60 min before subjecting them to the Presto Blue assay as described above. Curves were fit with the Boltzmann sigmoid equation to determine the time of 50% inhibition (IT50).

Solid-State Fermentation of Fungal Spores on the Example of Metarhizium brunneum F52

Fermentation of the M. brunneum strain F52 was performed in a modular solid state fermenter according to Liith and Eiben (see U.S. Pat. No. 6,620,614) with ˜1.5 kg grain-based cultivation substrate per module base and a constant airflow. The fermenter was placed in a room with a temperature of −22° C. The cooling system of the fermenter, which consisted of a cooling coil within each module base according to Liith and Eiben, was adjusted in such way that the cooling liquid was pumped through the cooling coil, when 25° C. were exceeded in the cultivation substrate, until it had cooled down again to 20° C. To apply the heat treatment during fermentation, the cooling liquid was replaced with 41° C. hot liquid, which resulted in a maximum temperature of 40° C. in the cultivation substrate. After termination of fermentation the spores were harvested by vacuuming and cyclonic separation. The spore powder was sieved (40 μm pore size) to remove fungal hyphae and residues of the cultivation substrate. Further processing of the harvested conidia included vacuum-drying which increased the relative dry mass of the spores from about 50% to about 92%. This drying step was applied in studies monitoring the long term shelf life of fungal spores for 3 months and longer.

### EXAMPLE 2: INFLUENCE OF A HEAT TREATMENT AT DIFFERENT TEMPERATURES ON CONIDIA ON THE EXAMPLES OF M. BRUNNEUM

### Protocol:

Spores of the M. brunneum strain F52 were spread on a PDA plate, and plates were incubated at 25° C. to allow germination, mycelial growth and formation of a new generation of conida, respectively. 12 days after inoculation, a timepoint at which conidiogenesis was completed, the plates were shifted to higher temperatures, i.e. 35° C., 37° C., 38° C., 39° C., 40° C., 41° C., 42° C. and 43° C. for 12 h. After this treatment plates were placed back to 25° C. Control plates were constantly incubated at 25° C. 14 days after inoculation (dai), conidia were harvested from the plates as described in Material & Methods. For determining the metabolic activity and the temperature tolerance of the respective spore suspensions, the Presto Blue assay was utilized (see Material & Methods). To study the storage stability of the spores, the suspensions were centrifuged and the supernatant was discarded. The spores were air-dried for several hours at room temperature, and then subjected to 30° C. for 1 week. The germination rate before and after this storage period was determined by incubating the spores for 20 h on PDA plates at 25° C. as described in Material & Methods. All assays were performed with two biological replicates.

### Results:

The investigation of the temperature tolerance and the short term storage stability (Table 1) revealed that applying a heat treatment to the spores can enhance the temperature tolerance of the spores as well as their storage stability. With respect to temperature tolerance we observed a more than three-fold increase of the IT50 at 44° C. (Table 1), and with respect to the storage stability we observed an about 10 fold increased germination rate, i.e. an increase from 1.9% germination of control spores to up to 18% germination after 1 week storage at 30° C. (Table 1). This effect showed a clear temperature dependency with regard to the heat treatment. While a treatment at 35° C. did hardly show an effect, the effect emerged at 37° C. and was most pronounced between 38° C. and 41° C. For this heat treatment setup of M. brunneum F52, temperatures above 41° C. led to an inhibition of the metabolic activity and germination.

TABLE 1
Influence of a heat treatment at different temperatures
on conidia on the examples of M. brunneum.

| | | | Germination | | | | | |
|---|---|---|---|---|---|---|---|---|
| | | | after 1 week | | Metabolic | | IT50 at | |
| | Germ. | | storage @ | | activity | | 44° C. | |
| sample | (%) | STDEV | 30° C. (%) | STDEV | (a.u.) | STDEV | (min) | STDEV |
| ctrl | 97.4 | 0.1 | 1.9 | 0.9 | 9.9 | 0.3 | 11.3 | 0.6 |
| 35° C. | 99.0 | 0.3 | 2.9 | 1.2 | 9.5 | 0.5 | 20.2 | 1.0 |
| 37° C. | 99.8 | 0.3 | 7.2 | 2.3 | 10.0 | 0.5 | 27.3 | 0.6 |
| 38° C. | 99.1 | 1.3 | 10.5 | 5.7 | 9.9 | 1.1 | 33.9 | 0.5 |
| 39° C. | 99.3 | 1.0 | 18.1 | 5.7 | 9.4 | 2.0 | 34.3 | 0.9 |
| 40° C. | 99.2 | 1.1 | 15.2 | 1.7 | 8.7 | 0.0 | 34.9 | 0.3 |
| 41° C. | 99.0 | 0.0 | 14.1 | 4.3 | 9.2 | 0.1 | 30.1 | 0.3 |
| 42° C. | 86.7 | 2.3 | 7.6 | 3.1 | 7.4 | 0.1 | 28.3 | 3.5 |
| 43° C. | 40.6 | 28.8 | 1.1 | 0.9 | 2.6 | 2.4 | 22.8 | 5.4 |

Germ.: Germination;
STDEV: standard deviation;
a.u.: arbitrary units

### EXAMPLE 3: INFLUENCE OF THE DURATION OF A HEAT TREATMENT ON CONIDIA ON THE EXAMPLES OF M. BRUNNEUM

### Protocol:

Spores of the M. brunneum strain F52 were spread on a PDA plate, and plates were incubated at 25° C. to allow germination, mycelial growth and formation of a new generation of conida, respectively. 12 days after inoculation, a timepoint at which conidiogenesis was completed, the plates were shifted to a temperature of 40° C. for 1 h, 3 h, 6 h 12 h, and 24 h, respectively. After this treatment plates were placed back to 25° C. Control plates were constantly incubated at 25° C. 14 days after inoculation, conidia were harvested and the metabolic activity and the temperature tolerance were determined as described in Material & Methods. To study the storage stability of the spores, the suspensions were centrifuged and the supernatant was discarded. The spores were dried at the air for 2 to 4 hours at room temperature, and then subjected to 30° C. for 1 week. The germination rate before and after this storage period was determined by incubating the spores for 20 h on PDA plates at 25° C. as described in Material & Methods. All assays were performed with two biological replicates.

### Results:

The investigation of the temperature tolerance and the short term storage stability (Table 2) revealed that a 40° C. treatment of 1 h was sufficient to increase temperature tolerance as well as storage stability. However these effects were most pronounced when the 40° C. treatment was applied for a time between 3 h and 12 h (Table 2), in such cases the temperature tolerance, i.e. the IT50 at 44° C., was increased almost three-fold, and the germination rate after storage at 30° C. for one week increased about five-fold, i.e. from about 1% to about 5%.

TABLE 2
Influence of the duration of a heat treatment
on conidia on the examples of M. brunneum

| | | | Germination | | | | | |
|---|---|---|---|---|---|---|---|---|
| | | | after 2 weeks | | Metabolic | | IT50 at | |
| | Germ. | | storage @ | | activity | | 44° C. | |
| sample | (%) | STDEV | 30° C. (%) | STDEV | (a.u.) | STDEV | (min) | STDEV |
| ctrl | 98.1 | 0.0 | 1.0 | 0.0 | 14.3 | 1.2 | 8.3 | 0.3 |
| 1 h | 96.8 | 1.7 | 1.7 | 0.3 | 14.1 | 0.4 | 13.7 | 1.1 |
| 3 h | 99.3 | 0.4 | 4.0 | 0.4 | 14.5 | 0.1 | 20.4 | 2.1 |
| 6 h | 94.4 | 0.1 | 4.9 | 0.3 | 13.7 | 0.4 | 21.7 | 0.4 |
| 12 h | 94.2 | 2.5 | 3.1 | 1.0 | 13.4 | 0.6 | 18.4 | 1.3 |
| 24 h | 70.8 | 0.5 | 1.0 | 0.0 | 8.0 | 1.4 | 12.5 | 0.5 |

### EXAMPLE 4: INFLUENCE OF THE TIMEPOINT OF HEAT TREATMENT ON CONIDIA ON THE EXAMPLES OF M. BRUNNEUM

### Protocol:

Spores of the M. brunneum strain F52 were spread on a PDA plate, and plates were incubated at 25° C. Plates were subjected to a heat treatment at 40° C. for 6 h after which temperature was lowered to 25° C. again. These temperature shifts were performed at different days after inoculation, i.e. on day 7, 9, 11, 12 and 13. Control plates were constantly incubated at 25° C. 14 days after inoculation, conidia were harvested and the metabolic activity and the temperature tolerance were determined as described in Material & Methods. To study the storage stability of the spores, the suspensions were centrifuged and the supernatant was discarded. The spores were air-dried for 2 to 4 hours at room temperature, and then subjected to 30° C. for 1 week. The germination rate before and after this storage period was determined by incubating the spores for 20 h on PDA plates at 25° C. as described in Material & Methods. All assays were performed with two biological replicates.

### Results:

The investigation of the temperature tolerance and the short term storage stability (Table 3) revealed that any of the time points during fungal development at which the 40° C. treatment was applied resulted in spores which were more tolerant towards elevated temperature, i.e. the IT50 at 44° C. increased about three-fold, and had increased storage stability, i.e. the germination rate after storage at 30° C. for one week increased from less than 1% to 5-8% depending on the time of application of the heat treatment. The highest increase of the storage stability was observed when the heat treatment was applied just one day before harvest (Table 3). Notably, applying the heat treatment at early time points, such as 5 and 7 days before harvest, the spore yield was negatively affected (Table 3), likely reflecting a dysfunction during conidiogenesis.

TABLE 3
Influence of the timepoint of heat treatment on conidia on the examples of M. brunneum.

| | | | Germination | | | | | | | |
|---|---|---|---|---|---|---|---|---|---|---|
| | | | after 1 week | | Metabolic | | IT50 at | | Yield | |
| | Germ. | | storage @ | | activity | | 44° C. | | (spores | |
| sample | (%) | STDEV | 30° C. (%) | STDEV | (a.u.) | STDEV | (min) | STDEV | per plate) | STDEV |
| ctrl | 98.3 | 0.4 | 0.2 | 0.3 | 16.4 | 1.3 | 14.6 | 0.8 | 4.02E+09 | 3.42E+08 |
| 7 dai | 97.8 | 0.3 | 5.0 | 0.3 | 15.9 | 0.7 | 33.6 | 3.2 | 2.56E+09 | 1.43E+08 |
| 9 dai | 98.3 | 0.2 | 5.1 | 0.3 | 16.7 | 0.2 | 36.6 | 3.5 | 3.05E+09 | 1.12E+09 |
| 11 dai | 98.7 | 0.3 | 7.0 | 0.6 | 17.2 | 1.4 | 36.6 | 1.2 | 3.79E+09 | 3.46E+07 |
| 12 dai | 98.3 | 0.5 | 6.4 | 1.2 | 18.4 | 0.2 | 37.7 | 0.6 | 3.76E+09 | 6.87E+08 |
| 13 dai | 98.4 | 0.7 | 8.1 | 0.3 | 16.5 | 0.4 | 40.6 | 3.0 | 4.14E+09 | 4.10E+08 |

dai: days after inoculation.

### EXAMPLE 5: INFLUENCE OF A RECOVERY PHASE AFTER HEAT TREATMENT ON CONIDIA ON THE EXAMPLES OF M. BRUNNEUM (2)

### Protocol:

Spores of the M. brunneum strain F52 were spread on PDA plates, and plates were incubated at 25° C. Spores were shifted to 40° C. for 12 h on day 13 after inoculation, i.e. 24 h before harvest. These spores were compared with spores which were shifted to 40° C. for 12 h on day 14 after inoculation, i.e. the heat treatment has been performed directly before harvest. The harvested conidia were subjected to the Presto Blue metabolic activity assay as described in Material & Methods. To study the storage stability of the spores, the suspensions were centrifuged and the supernatant was discarded. The spores were air-dried for 2 to 4 hours at room temperature, and then subjected to 30° C. for 2 weeks. The germination rate before and after this storage period was determined by incubating the spores for 20 h on PDA plates at 25° C. as described in Material & Methods. All assays were performed with two biological replicates.

### Results:

The investigation of the metabolic activity and the short term storage stability (Table 4) revealed that the spores which were heat treated directly before harvest were strongly affected in their metabolic activity and also showed reduced germination (Tables 4). Thus, a recovery phase is necessary to build the desired traits of spore robustness after heat treatment.

TABLE 4
Influence of a recovery phase after heat treatment
on conidia on the examples of M. brunneum

| | | | Germination | | | |
|---|---|---|---|---|---|---|
| | Germi- | | after 1 week | | Metabolic | |
| | nation | | storage @ | | activity | |
| | (%) | STDEV | 30° C. (%) | STDEV | (a.u.) | STDEV |
| dai 13 | 97.3 | 0.4 | 17.8 | 2.9 | 11.3 | 0.5 |
| dai 14 | 43.9 | 3.7 | 0.5 | 0.7 | 1.1 | 0.5 |
| (no re- | | | | | | |
| covery) | | | | | | |

### EXAMPLE 6: INFLUENCE OF RECOVERY TEMPERATURE AND DURATION AFTER HEAT TREATMENT ON CONIDIA ON THE EXAMPLE OF M. BRUNNEUM (2)

### Protocol:

Spores of the M. brunneum strain F52 were spread on a PDA plate, and plates were incubated at 25° C. Either 10 days after inoculation or 12 days after inoculation, plates were subjected to a heat treatment at 40° C. for 6 h after which temperature was lowered to either 25° C. or 10° C. Control plates were constantly incubated at 25° C. 14 days after inoculation, conidia were harvested and the metabolic activity and the temperature tolerance were determined as described in Material & Methods. To study the storage stability of the spores, the suspensions were centrifuged and the supernatant was discarded. The spores were air-dried for 2 to 4 hours at room temperature, and then subjected to 30° C. for 1 week. The germination rate before and after this storage period was determined by incubating the spores for 20 h on PDA plates at 25° C. as described in Material & Methods.

### Results:

The analysis revealed that a recovery phase at 10° C. for 2 days was not sufficient, reflected by the inability to germinate after 1 week storage at 30° C. (Tables 5). By contrast, increasing the recovery phase at 10° C. from 2 days to 4 days, a strong increase in storage stability was observed when compared to the control spores. This increase was even more pronounced than the increased storage stability using a recovery temperature of 25° C. (Table 5).

TABLE 5
Influence of a recovery temperature after heat
treatment on conidia on the examples of M. brunneum

| | | | Germination | |
|---|---|---|---|---|
| | | | after 1 week | |
| | Germination | | storage @ | |
| | (%) | STDEV^{a} | 30° C. (%) | STDEV^{a} |
| ctrl | 98.8 | #N/V | 5.9 | #N/V |
| 2 days 25° C. | 98.3 | #N/V | 13.8 | #N/V |
| recovery | | | | |
| 4 days 25° C. | 96.9 | #N/V | 14.0 | #N/V |
| recovery | | | | |
| 2 days 10° C. | 89.3 | #N/V | 0.0 | #N/V |
| recovery | | | | |
| 4 days 10° C. | 95.5 | #N/V | 17.3 | #N/V |
| recovery | | | | |

^{a}the assay was not performed in replicates

### EXAMPLE 7: EFFECT OF A HEAT TREATMENT IN LARGE-SCALE FERMENTATION ON THE EXAMPLE OF M. BRUNNEUM

### Protocol:

Two different batches of spores of the M. brunneum strain F52 were produced by solid state fermentation as described in Example 1. In one batch, the fermenter was heated for 12 h with 41° C. hot liquid at day 19 after inoculation. After this heat treatment, the fermenter was allowed to cool down to room temperature (about 22° C.). 21 days after inoculation the conida were harvested. Thus, the recovery phase constituted almost 2 days. The other batch was a conventional fermentation run without any heat treatment. Details on the fermentation and harvest procedures are given in the Material & Methods section. Aliquots of vacuum-dried spores were vacuum-sealed in aluminum bags and stored at 25° C. The spores stored in this way were subjected to germination assays at different timepoints. For selected samples the metabolic activity was determined using the Presto Blue assay.

### Results:

The results revealed an improved germination rate through the heat treatment of the fermenter (Table 6), i.e. germination was 1.2-fold increased after 2 weeks storage, two-fold increased after 3 months, and six-fold increased after 6 months. Furthermore, measuring the metabolic activity of the spores after 6 months storage at 25° C. revealed an 18-fold higher metabolic activity of the spores derived from the heat treated fermenter (Table 6).

TABLE 6
Effect of a heat treatment in large-scale fermentation
on the example of M. brunneum

| | | | | | Metabolic |
|---|---|---|---|---|---|
| | Germination after storage at 25° C. (%) | | | | activity (a.u.) |
| | 0 weeks^{a} | 2 weeks^{a} | 3 months^{b} | 6 months^{b} | 6 months |
| F52 | 92.0 | 65.4 | 33.1 | 8.5 | 4.5 |
| F52 + | 92.3 | 79.4 | 65.4 | 54.3 | 82.7 |
| heat | | | | | |

^{a}Germination of spores was determined after 20 h incubation on PDA at 25° C.
^{b}Germination of spores was determined after 40 h incubation on PDA at 25° C.

### EXAMPLE 8: EFFECT OF A HEAT TREATMENT ON A DIFFERENT FUNGAL STRAIN

### Protocol:

Spores of the Metarhizium acridum strain ARSEF324 (the active ingredient of Green Guard) were spread on PDA plates, and plates were incubated at 25° C. 12 days after inoculation, a time point at which conidiogenesis was completed, the plates were shifted to 40° C. for 6 h. After this treatment plates were placed back to 25° C. Control plates were constantly incubated at 25° C. 14 days after inoculation, conidia were harvested from the plates as described in Material & Methods. For determining the metabolic activity and the temperature tolerance of the respective spore suspensions, the Presto Blue assay was utilized (see Material & Methods). Since the ARSEF324 strain is described to be generally more temperature tolerant than the F52 strain, a slightly different setup was chosen: the spore suspensions were incubated at 44° C. for 0 min (control), 5 min, 10 min, 20 min, 30 min, 60 min and 120 min. To study the storage stability of the spores, suspensions were centrifuged and the supernatant was discarded. The spores were air-dried for 2 to 4 hours at room temperature, and then subjected to 30° C. for 2 weeks. The germination rate before and after this storage period was determined by incubating the spores for 20 h on PDA plates at 25° C. as described in Material & Methods. All assays were performed with two biological replicates.

### Results:

The investigation of the temperature tolerance and the short term storage stability (Table 7) revealed that both traits were improved through the heat treatment (Table 7). Additionally, it was observed that the metabolic activity of the heat treated spores was more than two-fold increased, indicating that the heat treatment in this isolate generally stimulates vitality.

TABLE 7
Effect of a heat treatment on a different fungal strain

| | | Germination | | | | | |
|---|---|---|---|---|---|---|---|
| | | after 2 weeks | | Metabolic | | IT50 at | |
| | Germination | storage @ | | activity | | 44° C. | |
| sample | (%) | 30° C. (%) | STDEV | (a.u.) | STDEV | (min) | STDEV |
| ARSEF | 97.6 | 59.6 | 11.2 | 7.7 | 0.7 | 30.6 | 1.2 |
| 324 | | | | | | | |
| ARSEF | 97.2 | 87.4 | 5.15 | 20.3 | 6.9 | 62.6 | 13 |
| 324 + | | | | | | | |
| heat | | | | | | | |

1. A method for producing dormant fungal structures or organs with an improved germination rate comprising subjecting said dormant structures or organs to a procedure comprising a heat treatment of between 37° C. and 65° C., followed by a cooling period to a temperature of between 0° C. and 36° C.

2. The method according to claim 1, further comprising producing said dormant fungal structures or organs by fermentation.

3. The method according to claim 2, wherein said dormant fungal structures or organs are subjected to said procedure during or after fermentation.

4. The method according to claim 1, wherein said dormant fungal structure or organs are exospores or spores which are developing spores or mature spores.

5. (canceled)

6. The method according to claim 2, wherein said fermentation is solid-state fermentation.

7. The method according to claim 1, wherein said dormant fungal structures or organs are spores of at least one filamentous fungus.

8. The method according to claim 7, wherein said at least one filamentous fungus is an entomopathogenic fungus.

9. The method according to claim 8, wherein said entomopathogenic fungus is of the genus Metarhizium.

10. The method according to claim 9, wherein said entomopathogenic fungus is of the species Metarhizium brunneum and/or Metarhizium acridum.

11. The method according to claim 8, wherein said entomopathogenic fungus is selected from the group consisting of Beauveria bassiana; Lecanicillium lecanii; Lecanicillium muscarium; Metarhizium brunneum; M. acridum ARSEF324; M. acridum isolate IMI 330189 (ARSEF7486); Nomuraea rileyi; Isaria fumosorosea strain apopka 97, Isaria fumosorosea strain FE 9901; and Beauveria brongniartii.

12. The method according to claim 7, wherein said at least one filamentous fungus is selected from the group consisting of a plant growth promoting fungus, a fungus active against plant pathogens, a fungus active against nematodes and a fungus having herbicidal activity.

13. The method according to claim 12, wherein said plant growth promoting fungus is selected from the group consisting of Talaromyces flavus, Trichoderma atroviride; Trichoderma harzianum; Penicillium bilaii; Pythium oligandrum; Rhizopogon amylopogon; Rhizopogon fulvigleba; Trichoderma harzianum; Trichoderma koningii; Trichoderma virens; and Verticillium albo-atrum.

14. (canceled)

15. The method according to claim 1, wherein said heat treatment comprises an elevation of the temperature within a spore containing vessel to between 37 and 55° C.

16. The method according to claim 1, wherein said dormant structure or organs are fungal spores.

17. The method according to claim 1, wherein said heat treatment is effected for at least 30 minutes.

18. The method according to claim 1, wherein said cooling period is at between 5° C. and 36° C.

19. The method according to claim 1, wherein said cooling period lasts at least 6 hours.

20. The method according to claim 1, wherein said dormant fungal structures or organs exhibit an increased germination rate as compared to dormant fungal structures or organs not subjected to said procedure after 2 weeks.

21. A composition comprising dormant fungal structures or organs having an improved germination rate, said composition comprising
a) a carrier; and
b) dormant fungal structures or organs subjected to a procedure comprising a heat treatment at a temperature of between 37° C. and 65° C. followed by a cooling period at a temperature of between 0° C. and 36° C.,
wherein 2 weeks after finishing said procedure said dormant fungal structures or organs exhibit an improved germination rate and/or germination efficiency as compared to dormant fungal structures or organs not subjected to the treatment in step b).

22. A storage-stable composition comprising dormant fungal structures or organs that are fungal spores which have been produced according to the method of claim 1.

23-26. (canceled)
